(19) United States
(12) Patent Application Publication
(10) Pub. No.: US 2010/0274445 A1
(43) Pub. Date: Oct. 28, 2010

(54) Apparatus and method for active stabilization of a two wheeled single track vehicle

(76) Inventor: Robin Haynes, (US)

Correspondence Address: Robin Haynes, Suite 321, 2280 Grass Valley Hwy, Auburn, CA, 95603, US

(21) Appl. No.: 12/430,076

(22) Filed: Apr. 25, 2009

(51) Int. Cl. B60W 30/02; B62H 1/12

(52) U.S. Cl. 701/36; 180/209

(57) ABSTRACT

The herein described apparatus and method for active stabilization of two wheeled single track vehicle utilizes lateral stabilizers to actively hold a two wheeled single track vehicle upright when stationary and at an angle coincident with the resultant angle of gravitational and lateral forces acting on the vehicle when at slow speed. The stabilizers automatically retract when the vehicle exceeds a predetermined speed and automatically deploy when the vehicle drops below a predetermined speed. Stabilizers are automatically deployed at an angle that causes both left and right stabilizers to contact the ground at essentially the same time.

### BACKGROUND OF THE INVENTION

When traveling at sufficient speed, the operator of a two wheeled single track vehicle is able to balance and steer the vehicle with very little effort, since the mass of the vehicle and the forces acting on it tend to create a natural equilibrium. When a single track vehicle is traveling in a straight line, the forces acting on it resolve to hold it essentially vertical. When turning, the vehicle will naturally adopt an angle of lean so that the vertical center line of the vehicle is coincident with the resultant angle created by gravity and lateral acceleration acting through its mass. The precise physics of the system that creates this equilibrium has been the subject of extensive study and is complex. Lean and steer are coupled by a combination of effects, including gyroscopic forces, lateral ground-reaction forces, gravity and inertial forces. In fact it requires a set of mathematical equations, with many separate variables, to describe every aspect of such a vehicles balance and stability. It is beyond the scope of this document to explain the system in any further detail and, therefore, the background of this invention, begins with the premise that, at sufficient speed, a single track vehicle requires no particular skill to maintain balance or directional control. As the speed of the vehicle reduces, however, the inherent stabilizing forces begin to degrade until they become zero at or near zero speed. It is in this slow speed range where auxiliary stabilization is required.

At its most basic, as with motorcycles and bicycles, the operators legs and feet perform the function of auxiliary stabilizers—being deployed as the vehicle is stopped. This method is cheap, simple and intuitive, and has been used by operators of single track vehicles from the very first bicycle. There are, however, three notable problems with this solution: 1) Using the feet and legs as stabilizers requires physical strength and coordination beyond the ability of many people. 2) In order for the operators feet to be available, the vehicle cannot be fully enclosed. 3) The feet cannot be used for stabilization when the vehicle is moving, so maneuvering at slow speed is difficult, requiring both balance and skill. There have been many prior attempts to overcome these problems so that a two wheeled single track vehicle could have an ease of use comparable with dual track, three or four wheeled vehicles. In particular, many designers have concluded that a fully enclosed two wheeled, single track vehicle could be both extremely fuel efficient and comfortable, if the low speed stability problems could be overcome.

The prior art includes patents and non patented devices and methods. There are examples of stands for supporting a stationary vehicle, fixed stabilizers to prevent or limit the lean angle of a moving or stationary vehicle, and retractable stabilizers that are deployed to limit or control the lean angle of a vehicle as needed.

Since the present invention is retractable, more detailed attention shall be given this category of prior art. Most inventions propose to deploy the stabilizers to a fixed position which effectively holds the vehicle perpendicular to the road surface. While this is the simplest arrangement, it does introduce further complications. Depending on the turn angle and speed of the vehicle, the stable angle is unlikely to be coincident with an angle 90° to the road surface, so this arrangement will rarely hold the vehicle at an appropriate angle. This arrangement also makes for a difficult and unnatural transition when the stabilizers are deployed or retracted and, therefore, automatic retraction and deployment of stabilizers of this kind is impractical. The operator is required to take into account both current and near future events, and to coordinate with other actions, before “choosing the right moment” to either deploy or retract the stabilizers. Manual deployment and retraction requires an extra level of operator skill, however, and is therefore also not an adequate solution. Other examples of retractable stabilizers allow the angle of lean angle to be manually set by actuating levers, pedals, or other controls. This also introduces a set of extra demands on the operator that the present inventor considers to be unacceptable. Still other examples propose to let the stabilizers move freely and only lock them if the angle of lean is not within certain parameters or to have the stabilizers provide a minimal force that can be overcome by operator intention. Both of the examples, while being possibly novel, do not provide a sensible or viable solution for safe vehicle operation. A further example, of a non patented invention, provides for an automatic degree of lean dependant on steering input. While this is an improvement on fixed position stabilizers, it does not automatically position the vehicle to the angle of equilibrium and so does not address the transitional problems associated with retraction. A still further example allows the stabilizing force to be reduced as speed increases, provided that lateral acceleration forces are minimal (if the vehicle is positioned close to the angle of equilibrium). This is an improvement on earlier inventions because it allows an automatic retraction to occur only in a safe condition, however, it does not solve the deployment problem or allow transparent, automatic operation.

In Summary, no prior art teaches an apparatus or method for using auxiliary stabilizers during slow speed operation that automatically maintain the vehicle at the angle of equilibrium and automatically and seamlessly retract as speed increases. Similarly, no prior art teaches an apparatus or method for deploying auxiliary stabilizers that automatically and seamlessly maintain the vehicle at its angle of equilibrium as the vehicles speed is reduced. Also, no prior art teaches any method or apparatus for deploying stabilizers at an angle that matches the vehicles current angle to the road surface, regardless of the vehicles speed and rate of turn at that time, so that both left and right stabilizers contact the road surface at essentially the same time. The present inventor considers this to be an essential requirement for the safe and manageable operation of such a stabilized vehicle.

### BRIEF SUMMARY OF THE INVENTION

The present invention comprises a method and apparatus for providing dynamic stability to a two wheeled, single track vehicle. The invention may be applied to an existing vehicle or incorporated into the design of a new vehicle. When the vehicle is maneuvering at low speed, the stabilizers automatically maintain the angle of the vehicles vertical center line to coincide with the vehicles natural angle of equilibrium. When the vehicles speed increases, the stabilizers automatically retract and, since the vehicles lean angle has been maintained at a natural angle, the transition is seamless and transparent to the operator. When the vehicles velocity drops to a predetermined speed the stabilizers are automatically deployed at an angle equal to the vehicles current angle to the road surface, so that both stabilizer wheels contact the road surface at essentially the same time. Thereafter the stabilizers continue to maintain the vehicles lean angle coincident with its angle of equilibrium. In this way the deployment of the stabilizers and subsequent stabilization is also seamless and transparent to the operator. The advantage this present invention has over all other prior art is in allowing a two wheeled, single track vehicle to be operated with more confidence and less skill at slow speed, with a seamless and transparent deployment and retraction of the active stabilizers as necessary. The invention makes it possible for a two wheeled, single track vehicle to be stabilized entirely by this method and, since the operators legs are never used, it makes it possible for the vehicle to be fully enclosed. The invention also makes it possible for a two wheeled in line vehicle to require no more operator skill than does a 3 or 4 wheeled vehicle. The invention further ads to operational safety by providing automatic deployment of the stabilizers if the main wheels lock up and skid on braking—as in a poorly executed emergency stop.

Accordingly it is a principal object of the invention to provide an improved stabilization method and apparatus for two wheeled, single track vehicles traveling at slow speed that actively maintains the vehicles lean angle at the angle of equilibrium. It is another object of the invention to provide a method and apparatus for seamlessly and transparently transitioning a two wheeled, single track vehicle between active stabilization at slow speed to no active stabilization at higher speed. It is a further object of the invention to provide a stabilization system for a two wheeled, single track vehicle that automatically deploys in an emergency situation where the vehicles main wheels are locked, as in a skid.

### DETAILED DESCRIPTION OF THE PREFERRED EMBODIMENT—DESCRIPTION OF DRAWINGS

A preferred embodiment of the present invention is an actively stabilized motorcycle. There are two aspects to the method and apparatus, a mechanical aspect comprising physical components and a digital aspect comprising a controller means that accepts input signals from sensors and sends control signals to mechanical actuators.

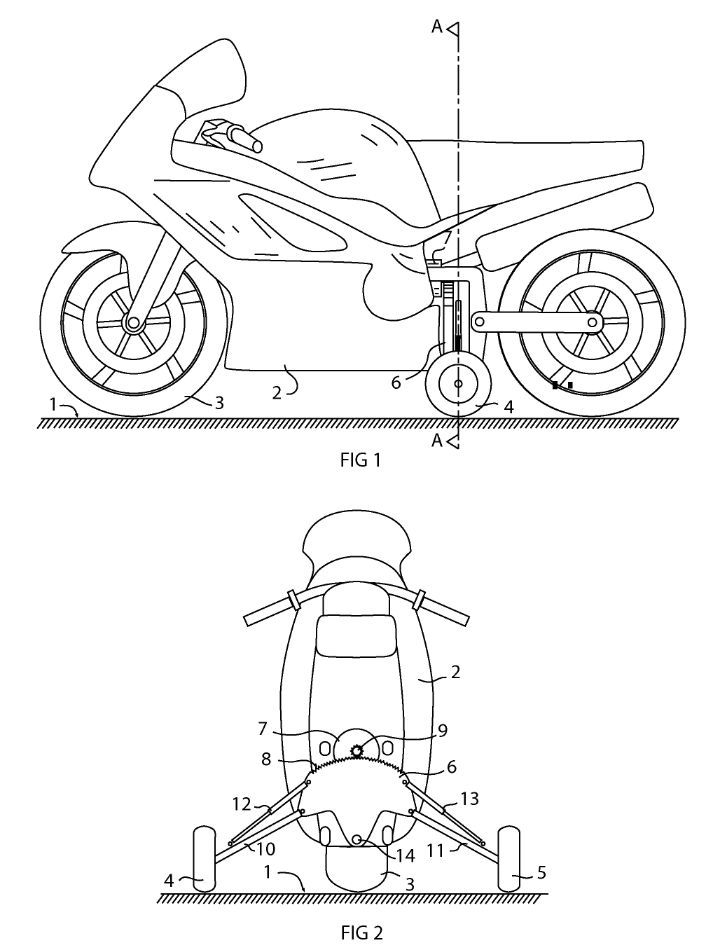

FIG. 1 is a side view of the motorcycle standing on the ground 1, showing the body 2 with front and rear wheels, 3 and 19. Left stabilizer wheel, 4 with bearing means 21, is shown in the deployed position. A cross sectional indicator line A-A passes vertically through the center of the stabilizer wheels. FIGS. 2 through 9 are views of cross section A-A as seen from the rear of the vehicle.

FIG. 2 shows the motorcycle body 2 in an upright position, front wheel 3 is in contact with the ground 1, left and right stabilizer wheels 4 & 5 are deployed and also in contact with ground 1. Left stabilizer wheel 4 is connected to arm 10 by a transverse bearing means 21 that allows wheel to turn freely when motorcycle is moving. The medial end of arm 10 is attached to carriage 6 by a longitudinal bearing means 25. One end of linear actuator 12 is connected to carriage 6 by a longitudinal bearing means 19. The other end of linear actuator 12 is connected to arm 10 by longitudinal bearing means 23. Being bilaterally symmetrical, right stabilizer wheel 5 is connected to arm 11 by a transverse bearing means 22 that allows wheel 5 to freely turn when motorcycle is moving. The medial end of arm 11 is attached to carriage 6 by a longitudinal bearing means 26. One end of linear actuator 13 is connected to carriage 6 by longitudinal bearing means 20. The other end of linear actuator 13 is connected to arm 11 by longitudinal bearing means 24. Deployment and retraction of the stabilizers occurs when controller means signals linear actuators % and % to become longer or shorter. At their shortest length the stabilizers are fully retracted, at their longest length the stabilizers are full deployed.

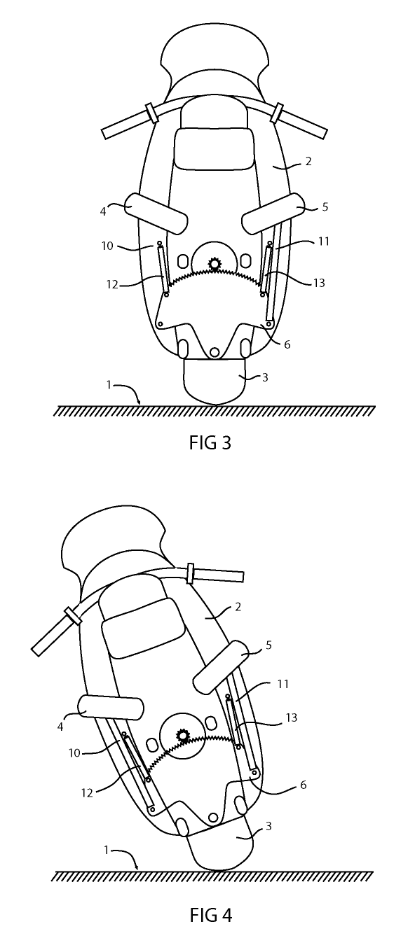

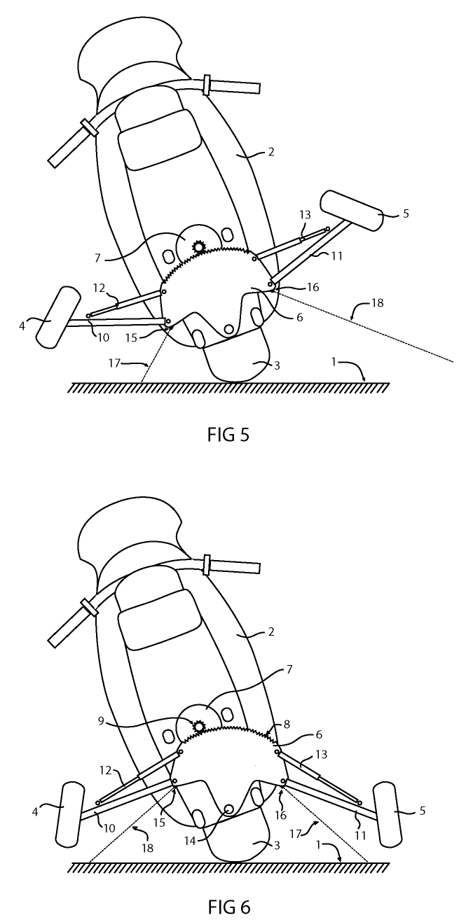

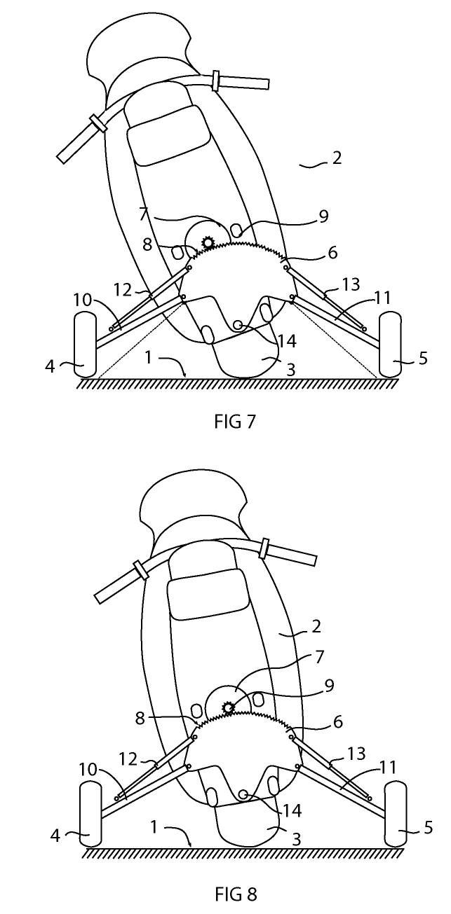

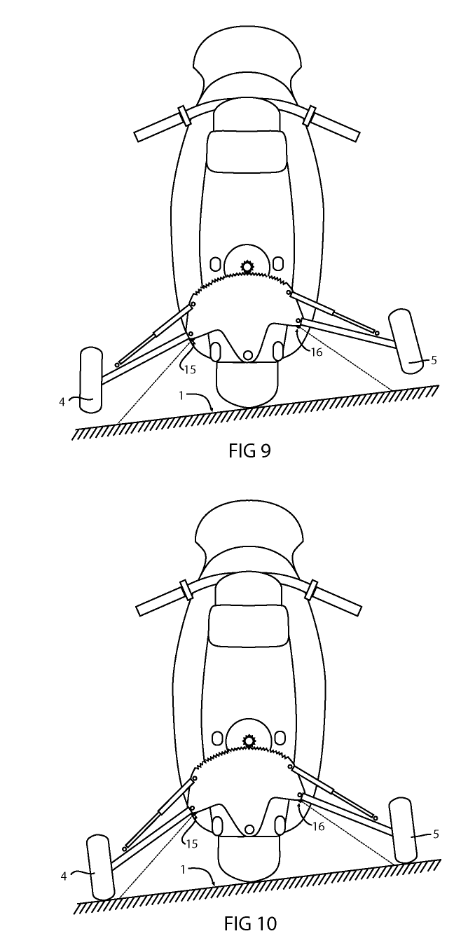

FIG. 3 shows motorcycle in an upright position on a horizontal surface with stabilizers in the fully retracted position, as would be the case when motorcycle is traveling at speed in a straight line on a laterally horizontal road. FIG. 4 shows motorcycle with stabilizers retracted and leaning at and angle of 20° to the left—as might be the case when navigating a left turn. The deployment sequence proceeds in the following manner. FIG. 5 shows motorcycle in the same 20° angle but now the motorcycle has decelerated to a predetermined speed so that the controller means has started the deployment sequence and the stabilizers are partially deployed. A positioning sensor means signals controller means that the deployment has reached a predetermined stage where wheels 4 & 5 are sufficiently clear of motorcycle body 2 as to allow carriage 6 to rotate left or right around bearing means 14. Controller means then uses data from left and right rangefinder means, 15 and 16 to measure the angle that carriage 6 makes with the ground 1. Controller means then signals actuator 7 working through pinion means 9 and rack means 8 to rotate carriage 6 to a position essentially parallel to the ground 1. As the stabilizers continue to deploy, any change in the motorcycles angle to the ground, is monitored by controller means and the angle of carriage 6 adjusted so it is maintained essentially parallel to the ground. FIG. 6 shows left and right stabilizers 4 and 5 almost fully deployed and, since carriage 6 is essentially parallel to the ground 1, both left and right stabilizer wheels 4 and 5 are essentially equidistant from the ground. As the stabilizers become fully deployed, both left and right stabilizer wheels, 4 and 5, are caused to contact the ground at essentially the same moment, making for a smooth and seamless transition to the fully deployed state. FIG. 7 shows the deployment as it is completed, with both left and right stabilizer wheels, 4 & 5, having contacted the ground 1. The method and apparatus described herein is able to accommodate usual and unusual combinations of motorcycle lean angle and lateral road angle. FIG. 9 shows the tertiary stage of deployment of stabilizers when the vehicle is traveling straight on a laterally tilted surface. Using data from rangefinder means, 15 & 16, controller means maintains both left and right stabilizer wheels 4 and 5 essentially equidistant from the ground 1. FIG. 10 shows the moment when stabilizers become fully deployed. Both left and right stabilizer wheels, 4 and 5, have contacted the ground 1 at essentially the same moment, making for a smooth and seamless transition to the fully deployed state.

The sequence of retraction of the stabilizers is essentially the opposite of deployment. When the vehicles speed increases to a predetermined speed, controller signals left and right linear actuators, 12 and 13, to shorten so that arms 10 and 11 rotate about bearing means 25 and 26. During the initial stage of retraction, controller means maintains carriage 6 essentially parallel to the ground 1 using data from rangefinder means 15 and 16. When the retraction has reached a predetermined point, so that left and right stabilizer wheels 4 and 5 are clear of the ground, controller means signals carriage 6 to rotate so that its angle is coincident with the motorcycle body 2, allowing stabilizers to be fully retracted. Retraction of stabilizers will only occur when the vehicles lean angle is coincident with the resultant angle of equilibrium, or at an angle that is within a predetermined tolerance from the resultant angle of equilibrium. In this way, the transition from stabilized to un-stabilized state is seamless, transparent and automatic.

Upon deployment, a positioning sensor means signals controller means that the stabilizers are fully deployed. The controller means then maintains the lean angle of the motorcycle to be coincident with the angle of equilibrium by using lateral acceleration data from an accelerometer means fixed to the motorcycle body. If the lean angle of the motorcycle is coincident with the angle of equilibrium the accelerometer will measure zero. If the lean angle is not coincident with the angle of equilibrium, the accelerometer will measure a value either left or right. The accelerometer data is used by controller means to generate a signal that causes rotational actuator 7 to turn pinion 9 which acts on rack 8 and in turn rotates carriage 6. This action pushes either left or right stabilizer, 4 or 5, wheels against the ground 1 and thus adjusts the lean angle of the motorcycle towards the angle of equilibrium. When ever the vehicle is in motion with stabilizers fully deployed, controller means samples data from rangefinder means several times per second and sends resultant signals to the rotational actuator in order to maintain the motorcycles lean angle essentially coincident with the angle of equilibrium.

I claim:

1. An active stabilization method and apparatus for a two wheeled, single track vehicle comprising two retractable stabilizer wheels that automatically deploy when the speed of the vehicle drops below a predetermined speed.

2. An active stabilization method and apparatus for a two wheeled, single track vehicle comprising left and right retractable stabilizer wheels that automatically retract when the speed of the vehicle increases above a predetermined speed.

3. An active stabilization method and apparatus including left and right stabilizer wheels connected to a carriage unit that is able to rotate on the vehicles longitudinal axis.

4. An active stabilization method and apparatus according to claim 3 including rotational actuator means that rotates stabilizer carriage relative to the vertical center line of vehicle.

5. An active stabilization method and apparatus according to claim 3 including rangefinder means to measure the angle of the stabilizer carriage relative to the ground.

6. An active stabilization method and apparatus according to claim 4 including a controller means to control operation of rotational actuator means so that stabilizer carriage is maintained at an angle proximately parallel to the ground during deployment of stabilizers, enabling both left and right stabilizer wheels to contact the ground at essentially the same time.

7. An active stabilization method and apparatus according to claim 3, including a lateral accelerometer means to monitor acceleration forces acting laterally to the vehicle vertical center line.

8. An active stabilization method and apparatus according to claims 3 and 5, including a controller means that, when stabilizers are fully deployed, controls the angle of the stabilizer carriage so as to maintain the vehicles lean angle coincident with the resultant angle of gravitational and lateral forces acting on the vehicle.
